(19) United States
(12) Patent Application Publication
(10) Pub. No.: US 2010/0275224 A1
(43) Pub. Date: Oct. 28, 2010

(54) System and Method for Information Delivery Including Delivery Via Video-Based Keyed or Tagged Content

(76) Inventors: Samuel Sheng, Los Gatos, CA (US); David Bydeley, San Jose, CA (US); Gary Levy, Los Gatos, CA (US); Qing Wang, Shanghai (CN)

Correspondence Address: NEIL STEINBERG, 2300 M STREET, N.W., Suite 800, WASHINGTON, DC, 20037, US

(21) Appl. No.: 12/766,128

(22) Filed: Apr. 23, 2010

Related U.S. Application Data
(60) Provisional application No. 61/172,478, filed on Apr. 24, 2009.
(60) Provisional application No. 61/182,080, filed on May 28, 2009.

(51) Int. Cl. H04H 60/32; G10L 15/04; G06K 9/46

(52) U.S. Cl. 725/14; 704/251; 382/195

(57) ABSTRACT

An interactive device/system of and method for delivery, receipt and/or decoding of and/or response to keyed or tagged video content provided in connection with one or more video broadcasts (for example, television or streaming video). Responsive thereto, the system and method may deliver and/or receive video and/or audio information. Such delivery and/or receipt of video and/or audio information may be responsive to content embedded in the broadcast but not visually observed, responsive to broadcast content that is visually observed and then parsed and correlated with a predetermined response, and responsive to a user/operator instruction, input and/or request. The interactive video receiving device may determine a video-based broadcast is an interactive video-based broadcast, wherein, the device automatically provides interaction options and or based on a response by the user/viewer to the video-based broadcast, the video receiving device transmits “interest-level” data (i.e., data which is representative of the viewer's level of interest to the video-based broadcast) to obtain additional information regarding the video-based broadcast. Other inventions are also disclosed.

### RELATED APPLICATIONS

This non-provisional application claims priority to (i) U.S. Provisional Application Ser. No. 61/172,478, entitled “System and Method of Automated Information Delivery via Video-Based Keyed or Tagged Content”, filed Apr. 24, 2009, and (ii) U.S. Provisional Application Ser. No. 61/182,080, entitled “System and Method for Information Delivery”, filed May 28, 2009 (collectively hereinafter “the Provisional Applications”); the contents of the Provisional Applications are incorporated by reference herein, in their entirety.

### INTRODUCTION

The present inventions relate to an interactive device/system of and method for delivery, receipt and/or decoding of and/or response to keyed or tagged video content provided in connection with one or more video broadcasts (for example, television or streaming video). Responsive thereto, the system and method may deliver and/or receive video and/or audio information. Such delivery and/or receipt of video and/or audio information may be responsive to a user/operator instruction, input and/or request.

In another aspect the present inventions relate to an interactive video receiving device/system and method. The video-based broadcast, in response to detecting an interactive video-based broadcast and based on a response by the viewer to the interactive video-based broadcast, transmits “interest-level” data (i.e., data which is representative of the viewer's level of interest to the video-based broadcast) to obtain additional information regarding the video-based broadcast. In response to “interest-level” data, additional information regarding the video-based broadcast may be specifically and/or uniquely directed to the viewer via the interactive video receiving device. Additional specific and/or unique interactivity may follow in view of the additional information. Notably, the additional information or interactivity may be video (graphic or text) and/or audio based.

In another aspect, the present inventions relate to a video receiving device/system which includes circuitry and implements techniques that facilitate decoding, analyzing and/or determining the programming content information available from, for example, the broadcast signal. Such data or information of the programming content may be included or embedded, for example, in the vertical blanking interval (VBI information). In addition thereto, or in lieu thereof, a video receiving device may decode, analyze and/or determine programming content from teletext information (or the like) available from or in the broadcast signals and/or any closed-captioning (CC) content information provided in or available from the broadcast signals. Moreover, the receiver circuitry may, in addition thereto or in lieu thereof, decode and/or analyze broadcast displayed content, for example, by analyzing pixel, color, shape, and/or pattern representations of the video content of the broadcast (such as logos, words, numbers, scoreboards, etc). In response to such data/information, the user or viewer may request additional information regarding the video-based broadcast or content thereof (for example, from the broadcaster or a central station). The additional information may thereafter be specifically and/or uniquely directed to the viewer via the interactive video receiving device. Indeed, additional specific and/or unique interactivity may follow in view of the additional information, which may be video (graphic or text) and/or audio based.

Notably, the video receiving device (or processing circuitry that interfaces with or to the video receiving device) may include or generate a database, lookup table or decision matrix whereby the processing circuitry provides the user or viewer incremental feature options based upon, for example, the decoded VBI information, teletext content information and/or pixel patterns corresponding to certain tagged events or conditions such as logos or scoreboards. For example, processing circuitry, in response to the decoded VBI information, teletext content information and/or pixel patterns, and based on the database, look-up table and/or decision matrix, may generate data to provide, for example, a pop-window to purchase a service or product, providing a pop-window with the option to place a vote for a participation TV game show (via for example, SMS communications protocol or an Internet TCP/IP connection), or providing a pop-window for the user to visit the website of the program content show, network, or advertisement.

In one aspect of the present inventions, transmitting or providing the additional information may be a revenue generating or bearing event—for example, the telephone provider, broadcaster and/or advertiser may charge the viewer/user/operator for the additional information. With this in mind, in other aspects, the present inventions are directed to a system, video receiving device, and/or central station, as well as methods, to implement these illustrative exemplary embodiments.

### SUMMARY

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

Importantly, the present inventions are neither limited to any single aspect nor embodiment, nor to any combinations and/or permutations of such aspects and/or embodiments. Moreover, each of the aspects of the present inventions, and/or embodiments thereof, may be employed alone or in combination with one or more of the other aspects and/or embodiments thereof. For the sake of brevity, certain permutations and combinations are not discussed and/or illustrated separately herein.

In a first principle aspect, certain of the present inventions are directed to circuitry and method of operating and interacting with a video receiving device. In one aspect, the method comprises receiving a video-based broadcast, wherein the video-based broadcast includes video data and key data, wherein the key data is indicative of an interactive video-based broadcast, displaying the video-based broadcast and decoding the key data and, in response thereto, determining the video-based broadcast is an interactive type video-based broadcast. The method further includes detecting a predetermined level of interest of the user in the video-based broadcast, transmitting data which is indicative of the predetermined level of interest of the user in the video-based broadcast and receiving first additional information in response to transmitting the data which is indicative of predetermined level of interest of the user in video-based broadcast, wherein the first additional information is associated with the video-based broadcast. The method of this aspect of the present inventions also includes concurrently displaying the video-based broadcast and data which is representative of the first additional information, detecting a response from the user to the first additional information and transmitting data which is indicative of the response from the user to the first additional information.

In one embodiment, the key data is embedded in the video data of the video-based broadcast. In another embodiment, the key data is embedded within one or more vertical blanking intervals of the video data of the video-based broadcast. In yet another embodiment, the key data is embedded within teletext information of the video-based broadcast. Indeed, the key data may be included in the closed-captioning data. The key data may be information or data which is representative of one or more characteristics of the associated video-based broadcast

In one embodiment, concurrently displaying the video-based broadcast and data which is representative of the first additional information further includes displaying the data which is representative of the first additional information as a video insert or a graphic overlay with respect to the video-based broadcast.

Notably, detecting a predetermined level of interest of the user in video-based broadcast is based on an amount of time of displaying the video-based broadcast. The predetermined level of interest may be specific to particular key data or may be general to a plurality of key data.

In another principle aspect, the present inventions are directed to a method of operating and interacting with a video receiving device having a user interface, wherein the method comprises receiving a video-based broadcast, receiving key data which is associated with the video-based broadcast, displaying the video-based broadcast, and decoding the key data—wherein, in response thereto, determining the video-based broadcast is an interactive type video-based broadcast. The method of this principal aspect also includes detecting a level of interest of the user in video-based broadcast based on an amount of time of displaying the video-based broadcast, transmitting data which is indicative of the level of interest, receiving first additional information in response to transmitting the data which is indicative of the level of interest and outputting data which is representative of the first additional information to the user interface. In addition, the method includes detecting a response from the user to the first additional information and transmitting data which is indicative of the response to the first additional information.

In one embodiment, receiving key data which is associated with the video-based broadcast includes receiving information pertaining to the content of the associated video-based broadcast via content-specific electronic program guide. Further, outputting data which is representative of the first additional information to a user interface may include displaying data which is representative of the first additional information. Indeed, displaying data which is representative of the first additional information may further include displaying the data which is representative of the first additional information as a video insert, a graphic overlay, or formatted text with respect to the video-based broadcast.

In one embodiment of this aspect of the inventions, the key data is embedded in the video data of the video-based broadcast. In another embodiment, the key data is embedded within one or more vertical blanking intervals of the video data of the video-based broadcast. In yet another embodiment, the key data is embedded within teletext information of the video-based broadcast. Indeed, the key data may be included in the closed-captioning data. The key data may be information/data which is representative of one or more characteristics of the associated video-based broadcast

In another embodiment, displaying the data which is representative of the first additional information further includes displaying the data which is representative of the first additional information as a SMS text message overlay on the video-based broadcast.

The method of this aspect of the inventions may further include receiving second additional information in response to transmitting the data which is indicative of the response from the user to the first additional information, outputting data which is representative of the second additional information to the user interface, and detecting a response from the user to the second additional information. Notably, outputting data which is representative of the second additional information to the user interface may include displaying data which is representative of the second additional information.

In another principle aspect, the present inventions are directed to a method of operating and interacting with a video receiving device having a user interface, wherein the method comprises: (i) receiving a video-based broadcast, wherein the video-based broadcast includes video data and text data embedded therein, (ii) displaying the video-based broadcast, (iii) analyzing the text data and, in response thereto, identifying predetermined and/or text, words and/or phrases of the text data, and (iv) outputting a contextually relevant presentation to the user interface in response to identifying the predetermined and/or text, words and/or phrases.

In one embodiment, outputting of the contextually relevant presentation to the user interface in response to identifying the predetermined and/or text, words and/or phrases further includes displaying a predetermined video insert on the user interface, wherein the predetermined video insert is associated with the predetermined and/or text, words and/or phrases of the text data. In another embodiment, outputting the contextually relevant presentation to the user interface in response to identifying the predetermined and/or text, words and/or phrases further includes presenting the user with a link to a website which is associated with the predetermined and/or text, words and/or phrases of the text data. Alternatively, outputting the contextually relevant presentation to the user interface in response to identifying the predetermined and/or text, words and/or phrases further includes providing the user with a product purchase coupon which is associated with the predetermined and/or text, words and/or phrases of the text data. Indeed, in one embodiment, outputting the contextually relevant presentation to the user interface in response to identifying the predetermined and/or text, words and/or phrases further includes providing the user with information which is representative of one or more physical locations which are correlated to an acquisition of a product that is associated with the predetermined and/or text, words and/or phrases of the text data.

Notably, outputting the contextually relevant presentation to the user interface in response to identifying the predetermined and/or text, words and/or phrases may include concurrently displaying the video-based broadcast and data which is representative of the contextually relevant presentation. Concurrently displaying the data which is representative of the contextually relevant presentation may include displaying the data which is representative of the contextually relevant presentation as a video insert or a graphic overlay with respect to the video-based broadcast.

In one embodiment, the key data is embedded in the video data of the video-based broadcast. In another embodiment, the key data is embedded within one or more vertical blanking intervals of the video data of the video-based broadcast. In yet another embodiment, the key data is embedded within teletext information of the video-based broadcast. Indeed, the key data may be included in the closed-captioning data. The key data may be information or data which is representative of one or more characteristics of the associated video-based broadcast.

The outputting contextually relevant presentation to the user interface in response to identifying the predetermined and/or text, words and/or phrases, in one embodiment, may include displaying data which is representative of the contextually relevant presentation as a SMS text message overlay on the video-based broadcast.

In another embodiment, the may further include detecting a response from the user to the contextually relevant presentation which is output to the user interface in response to identifying the predetermined and/or text, words and/or phrases. In another embodiment, the method may further include transmitting data which is indicative of the response from the user to the contextually relevant presentation. In yet another embodiment, the method of this aspect of the invention may further include (i) receiving first additional information in response to transmitting the data which is indicative of the response from the user to the contextually relevant presentation, and (ii) outputting data which is representative of the first additional information to the user interface. Indeed, the method, in another embodiment, may include (i) detecting a response from the user to the first additional information and (ii) transmitting data which is indicative of the response from the user to the first additional information.

In another principle aspect, the present inventions are directed to a method of operating and interacting with a video receiving device having a user interface, wherein the method comprises (i) receiving a video-based broadcast, (ii) displaying video data which is representative of the video-based broadcast, (iii) analyzing the video data to identify predetermined information contained therein, wherein the predetermined information includes logos, words and/or numbers, and wherein analyzing the video data includes analyzing the color, shape and/or pattern representations of the video data, and (iv) outputting one or more contextually relevant presentations to the user interface in response to identifying the predetermined information contained therein.

Notably, analyzing the video data to identify predetermined information contained therein further includes comparing color, shape and/or pattern representations of the video data to corresponding data in a database or look-up table which is representative of one or more logos, words and/or numbers.

As stated herein, there are many inventions, and aspects of the inventions, described and illustrated herein. This Summary may not exhaustive of the scope of the present inventions. Indeed, this Summary may not be reflective of or correlate to the inventions protected by the claims in this or in continuation/divisional applications hereof.

Moreover, this Summary is not intended to be limiting of the inventions or the claims (whether the currently presented claims or claims of a divisional/continuation application) and should not be interpreted in that manner. While certain embodiments have been described and/or outlined in this Summary, it should be understood that the present inventions are not limited to such embodiments, description and/or outline, nor are the claims limited in such a manner (which should also not be interpreted as being limited by this Summary).

Indeed, many other aspects, inventions and embodiments, which may be different from and/or similar to, the aspects, inventions and embodiments presented in this Summary, will be apparent from the description, illustrations and claims, which follow. In addition, although various features, attributes and advantages have been described in this Summary and/or are apparent in light thereof, it should be understood that such features, attributes and advantages are not required whether in one, some or all of the embodiments of the present inventions and, indeed, need not be present in any of the embodiments of the present inventions.

### BRIEF DESCRIPTION OF THE DRAWINGS

In the course of the detailed description to follow, reference will be made to the attached drawings. These drawings show different aspects of the present inventions and, where appropriate, reference numerals illustrating like structures, components, materials and/or elements in different figures are labeled similarly. It is understood that various combinations of the structures, components, and/or elements, other than those specifically shown, are contemplated and are within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein.

FIG. 1A is a schematic block diagram representation of an exemplary video receiving device, according to at least certain aspects of the present inventions, in conjunction with a video broadcast system having receive and transmit circuitry, according to at least certain aspects of the present inventions;

FIG. 1B is a schematic block diagram representation of an exemplary video receiving device, according to at least certain aspects of the present inventions, in conjunction with a video broadcast system;

FIGS. 2A-2E are block diagram representations of exemplary configurations of transmitting key or tag data with the video-based broadcast, wherein such key or tag data may be embedded within the video-based broadcast (FIGS. 2A, 2B, 2D and 2E) or separate therefrom (FIG. 2C);

FIGS. 3A and 3B are schematic block diagram representation of exemplary video receiving device(s) and central station, in accordance with at least certain aspects of the present inventions;

FIGS. 4A-4C are block diagram representation of exemplary user interfaces (display) of video receiving device depicting an information/data area overlay (which may be in graphic or text form), according to at least certain aspects of the present inventions;

FIG. 5 is a schematic block diagram representation of an exemplary video receiving device, according to certain aspects of the present inventions, in conjunction with external peripheral devices/circuitry, according to at least certain aspects of the present inventions;

FIGS. 6A-6G are block diagram representation of exemplary user interfaces of video receiving device, according to at least certain aspects of the present inventions;

FIG. 7 is a flow of an exemplary interactive process or operation of a video receiving device and broadcast system (wherein the operations thereof are indicated in dashed boxes), according to certain aspects of the invention;

FIGS. 8A-8C, 9A, 9B, 11A and 11B are exemplary video receiving devices, according to certain aspects of the present inventions, depicting an information/data area overlay, according to certain aspects of the present inventions; and

FIGS. 10, 12A and 12B are schematic block diagram representations of exemplary video receiving devices, according to certain aspects of the present inventions.

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed separately herein.

### DETAILED DESCRIPTION

There are many inventions described and illustrated herein, as well as many aspects and embodiments of those inventions. In one aspect, the present inventions relate to, among other things, an interactive system of and method for delivery, receipt and/or decoding of and/or response to keyed or tagged video content provided in connection with one or more video broadcasts (for example, television or streaming video). In response thereto, the system and method may deliver and/or receive additional video and/or audio information (in addition to the video broadcast). Such delivery and/or receipt of video and/or audio information may be responsive to a user/operator interest, instruction, input and/or request.

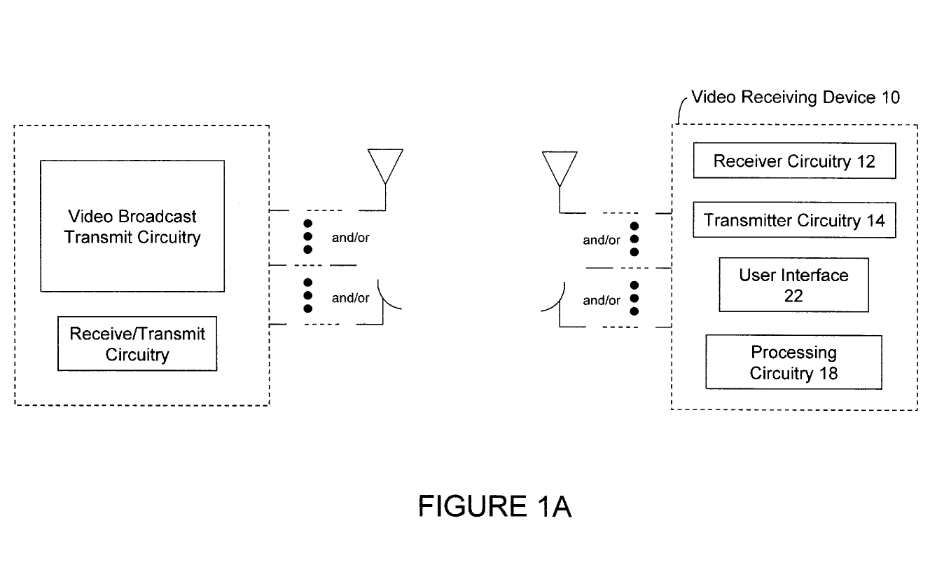

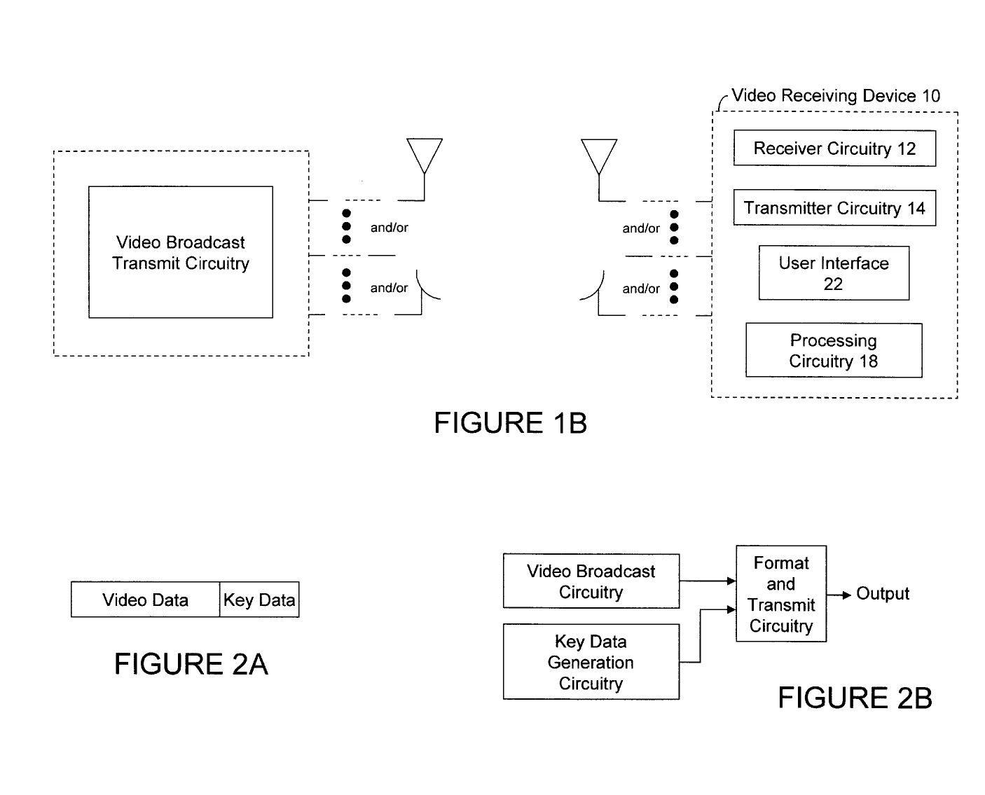

With reference to FIGS. 1A and 1B, the present inventions include a video receiving device 10 (for example, a mobile telephone or a laptop/desktop computer) having receiver circuitry 12 to receive a video-based broadcast and transmitter circuitry 14 to transmit information responsive thereto. In one embodiment, the video-based broadcast is keyed or tagged wherein the keyed or tagged video content includes, among other things, a video-based broadcast and key or tag data. The key or tag data (collectively hereinafter “key data”) is information or data which is representative of one or more characteristics of the video-based broadcast (for example, information regarding a characteristic or specific content of a particular video program, such as the program type or category (for example, a commercial, cooking program or sporting event) and/or program name (for example, Sports Center, Evening News, or Divine Design)).

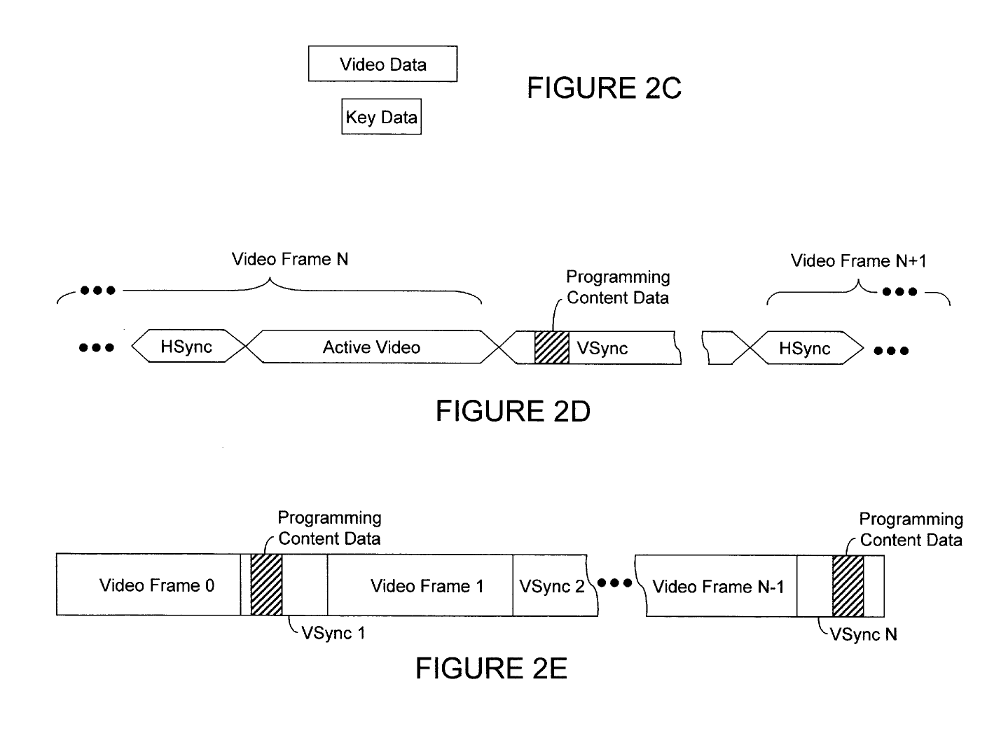

The key data may be embedded within the video-based broadcast, separate therefrom and/or determined from, for example, other data or information, for example, an electronic program guide (see, for example, FIGS. 2A-2C wherein the key data is embedded within the video-based broadcast (FIG. 2A), for example, via format and transmit circuitry (FIG. 2B) and/or transmitted separately from the video-based broadcast (FIG. 2C)). The video broadcast or video broadcasting may include, in addition to the broadcast of a particular video program, embedded information pertaining to the content of a particular video program, such as the program type or category and/or program name. Notably, in certain embodiments, the characteristics of the video-based broadcast may be determined from collateral information such as a content-specific electronic program guide (which may be transmitted or provided separately from the broadcast at issue).

In another aspect of the present inventions, the video receiving device includes circuitry and implements techniques that facilitate decoding, analyzing and/or determining the key data or programming content information available from, for example, the broadcast signal. Such data or information of the programming content may be included or embedded, for example, in one or more vertical blanking intervals (VBI information). (See, for example, FIGS. 2D and 2E). In addition thereto, or in lieu thereof, the video receiving device may decode, analyze and/or determine key data or programming content from teletext information (or the like) available from or in the broadcast signals. Such information may also be transmitted in the one or more vertical blanking intervals of a broadcast.

In one embodiment, the video receiving device (or processing circuitry that interfaces with or to the video receiving device) includes memory that stores, contains or includes a database, lookup table or decision matrix (which may be predetermined, generated by the video receiving device and/or modified, updated, changed, loaded and/or populated via an external transmission) whereby the processing circuitry implements or provides incremental feature options available to the user or operator based upon, for example, the decoded VBI information or teletext content information. For example, the processing circuitry, in response to the decoded VBI information or teletext content information and based on the look-up table or decision matrix, may generate data to output, display or provide a message, for example, via a pop-window, to, for example, purchase a service or product, offer the option to place a vote for a participation TV game show (via, for example, SMS communications protocol or an Internet TCP/IP connection), or offer the user to visit the website of the program content show, network, or advertisement.

In another embodiment, the video receiving device (or processing circuitry that interfaces with or to the video receiving device) may decode and/or analyze closed-captioning (CC) content information provided in or available from the broadcast signals. The video receiving device (having processing circuitry or coupled to processing circuitry) may include memory that stores, contains or includes a database, lookup table and/or decision matrix (which may be predetermined, generated by the video receiving device and/or changed, modified, updated, loaded and/or populated via an external transmission) whereby the processor implements or provides incremental feature options available to the consumer product user using character recognition (for example, optical character recognition) to decode, analyze and/or determine CC content information. In this regard, the processing circuitry, in response to the decoded CC content information and based on the look-up table or decision matrix, may generate data to output, display or provide a message to the viewer. For example, the processing circuitry, in response to correlating, comparing and/or matching decoded CC content information to data in the look-up table or decision matrix, may generate data to output, display or provide a message via a pop-window, to, for example, purchase a service or product, offer the option to place a vote for a participation TV game show (via, for example, SMS communications protocol or an Internet TCP/IP connection), or offer the user to visit the website of the program content show, network, or advertisement.

In addition thereto, or in lieu thereof, circuitry and techniques of the video receiving device (or processing circuitry that interfaces with or to the video receiving device) may analyze, decode and/or detect text information (for example, CC content information), which is provided with and/or embedded in the audio and/or video content of the broadcast, to search such broadcast to identify and/or detect predetermined and/or key text, words and/or phrases (such as “sale”, “World Cup”, “Olympics”, or “World Series”). In response to detecting such predetermined and/or key text, words and/or phrases, the video receiving device (or processing circuitry that interfaces with or to the video receiving device) may generate or provide contextually relevant presentations to the user or viewer, for example, a video insert or banner on the display. The user or viewer may define or select the predetermined and/or key text, words and/or phrases—which may be stored in memory on or in the video receiving device (or processing circuitry that interfaces with or to the video receiving device). In addition thereto, or in lieu thereof, such predetermined and/or key text, words and/or phrases may be generated by the video receiving device and/or changed, modified, updated, loaded and/or populated via an external transmission—and stored in memory on or in the video receiving device (or processing circuitry that interfaces with or to the video receiving device).

Notably, the contextually relevant presentation(s) may be provided via video (for example, an insert or banner on the display) and/or audio via a speaker coupled to or integrated in the video receiving device. In one embodiment, the contextually relevant presentations may be, for example, an advertisement, a phone number and/or game polling or voting. For example, the contextually relevant presentation may be presented on a video display, for example, a query to the viewer regarding a product, service or advertisement thereof—for example, the viewer may be presented with a question regarding whether he/she would like (i) more information about that product or service, (ii) a coupon against the next purchase of the product or service, and/or (iii) one or more locations where the product may be purchased (for example, the nearest location(s)). The viewer may also be presented with a query or question as to whether the viewer would like to be connected with an associated website or a link to the website may be presented to the viewer for access thereby. For example, the processing circuitry, in response to correlating, comparing and/or matching the detected predetermined and/or key text, words and/or phrases to data in the look-up table or decision matrix, may generate data to output, display or provide a message via a pop-window, to, for example, query or question the user or viewer whether he/she would like to be connected with an associated website.

In one exemplary embodiment, the predetermined and/or key text, words and/or phrases may be or may relate to a product, advertisement and/or a “jingle”. For example, where the user predetermined and/or key text, words and/or phrases is “Pepsi” or “Have a Pepsi”, “Coke”, and/or “Drink a Coke” and the broadcast (for example, TV broadcast) includes the word “Pepsi” or Coke” or the phrase “Have a Pepsi” or “Drink a Coke”, circuitry of the video receiving device (or processing circuitry that interfaces with or to the video receiving device) upon analyzing and/or decoding the CC content information and determining or detecting the selected predetermined and/or key text, word and/or phrase (for example, “Pepsi” or “Coke”), may generate, provide and/or present a contextually relevant presentation including, for example, a link to Pepsi's or Coke's website. Indeed, the user or viewer may be presented, for example, with a question regarding whether he/she would like (i) more information about that product or service, (ii) a coupon against the next purchase of the product or service, and/or (iii) one or more locations where the product may be purchased (for example, one or more of the nearest locations).

In another exemplary embodiment, circuitry of the video receiving device (or processing circuitry that interfaces with or to the video receiving device) may be configured to analyze and/or decode the broadcast (for example, TV broadcast) to detect or identify telephone numbers, website or texting instructions such as the text or phrase “Call 1-800-555-5555”. In this regard, the predetermined and/or key text, words and/or phrases may be a telephone number, website or texting information or instruction. The circuitry of the video receiving device may, in response to detecting such predetermined and/or key text, word and/or phrase (and based on database, lookup table and/or decision matrix (which may be predetermined, generated by the video receiving device and/or changed, modified, updated, loaded and/or populated via an external transmission)), generate and display a window or a button dialing option to the telephone number or site. Here, for example, the contextually relevant presentation is the window or a button dialing option to the telephone number or site which facilitates rapid and/or immediate access to a window or button that connects to the telephone number or site. In another embodiment, the circuitry, in response to detecting such predetermined and/or key text, word and/or phrase, and based on database, lookup table and/or decision matrix, may immediately connect the user or view to the telephone number or site. Such connection may be, for example, via telecom link or internet connection of the receiving device.

In another exemplary embodiment, the video receiving device includes circuitry and techniques to concurrently receive and/or display different communication mediums including (i) a TV broadcast and (ii) an overlay of specially designed SMS text messages (or the like). In this regard, the circuitry and techniques presents the SMS (or the like) communications as an overlay (for example, a graphical overlay) with respect to the picture or image generated from the TV broadcast. In one embodiment, the circuitry receives, analyzes, decodes and/or detects one or more specially designed text messages and, in response thereto, generates a graphical overlay of their contents on a broadcast TV picture.

In an additional embodiment, the video receiving device may include circuitry and/or techniques to scale or rescale the displayed content such that no content is obstructed or cropped by the overlays—for example, to accommodate with or conform to transmission standards and/or a particular country and/or government requirement and regulation. For example, the video receiving device may include a programmable mode that enables the video output circuitry to rescale the output video so that content is not obstructed or cropped by the overlays.

The text messages may include or contain formatted command words or messages or originate from a specific source (i.e. SMS originating from a configured number). In this regard, when the video receiving device (for example, mobile phone) which is tuned to receive or is viewing the TV broadcast concurrently receives, analyzes, decodes and/or detects one or more messages containing command words, the circuitry may generate and display additional on-screen information. The on-screen information may be, for example, sports scores, stock ticker information, news updates, etc. Indeed, the set of command words or messages may include commands to implement specific actions such as contact another viewer or friend (for example, via SMS communication) to, for example, suggest a TV program and/or change the selected channel thereof.

Notably, the present inventions may be employed in any transmission environment now known or later developed. For example, the receiver device may be implemented in a terrestrial and/or hardwired (for example, cable or fiber-optic) and/or satellite environment.

With reference to FIGS. 1A and 1B, in operation, video receiving device 10 receives the video-based broadcast. In certain embodiments, video receiving device 10 also receives (whether concurrently with the video-based broadcast or preceding such broadcast) and decodes information which is representative of the characteristics of the video-based broadcast. In response to the information which is representative of the characteristics of the video-based broadcast (which may be conveyed via key data that is (i) embedded in the program broadcast or separate therefrom, (ii) provided via information pertaining to the content of a particular video program, such as the program type or category and/or program name, and/or (iii) provided in collateral information such as a content-specific electronic program guide), video receiving device 10 determines whether the video-based broadcast is an interactive video-based broadcast. (See, for example, FIGS. 2A-2E). For example, video receiving device 10 may receive and decode key data (for example, via an electronic programming guide) which is associated with the video-based broadcast and, in response thereto, determine that the video-based broadcast is an interactive video-based broadcast.

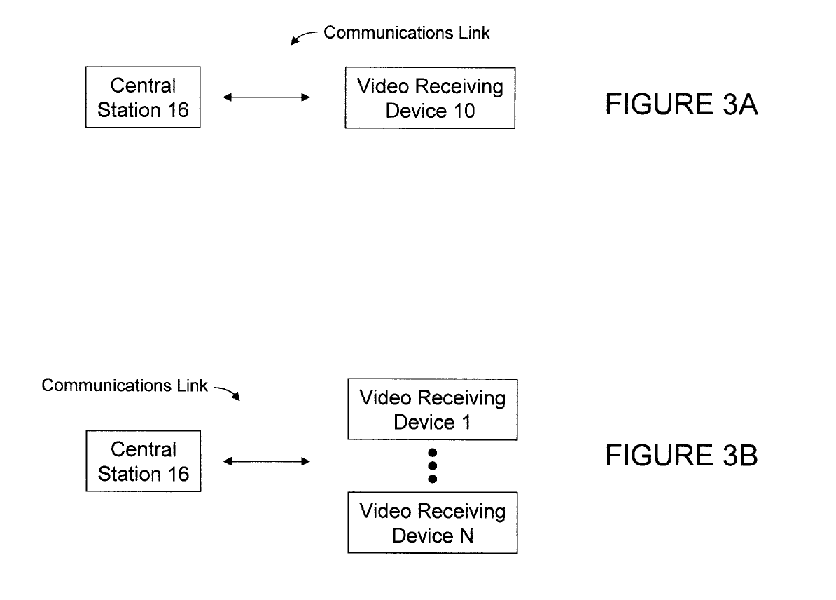

Under those circumstances where the video-based broadcast is an interactive video-based broadcast, video receiving device 10, based on a response of the operator, user and/or viewer (hereinafter collectively the “viewer”) to the video-based broadcast, transmits “interest-level” data (i.e., data which is representative of the viewer's level of interest to the video-based broadcast) to central station 16. For example, video receiving device 10, after determining, measuring and/or detecting a predetermined level of the viewer's interest to the video-based broadcast (via, for example, processing circuitry), may responsively query central station 16 (for example, as one or more servers which communicate with one or more video receiving devices, via, for example, SMS communications protocol or an Internet TCP/IP connection) for additional information regarding the video-based broadcast. (See, for example, FIGS. 3A and 3B). As such, central station 16, in response to “interest-level” data from video receiving device 10, transmits additional information or data to the viewer.

Notably, central station 16 and video receiving device 10 may communicate via any communications link and/or protocol now known or later developed. For example, the communications link may be wired or wireless and may be implemented in a terrestrial and/or cable and/or satellite environment. (See, for example, FIG. 1). In addition, the communications protocol may be, for example, standard, proprietary, Internet based or SMS; all communications protocols for the communications link between central station 16 and video receiving device 10 are intended to fall within the scope of the present inventions.

After receipt of such additional information from central station 16, video receiving device 10 may provide (visually or audibly) the data to the viewer of video receiving device 10. For example, central station 16 may transmit the additional information to video receiving device 10, thereby providing automated delivery of information based on, for example, key data and a predetermined level of interest to the video-based broadcast.

Notably, the level or amount of interest to generate, provide and/or attain a predetermined level may depend on the key information provided in connection with the video-based broadcast and decoded by video receiving device 10. In this regard, the extent or level of interest may be dependent on the specific key information of the particular video-based broadcast. As such, the level or amount of interest to generate, provide and/or attain a predetermined level may be generic or may be unique or specific to the particular key information or data, or unique or specific to the video-based broadcast.

In one embodiment, the level of interest may be a measure of the extent video receiving device 10 is tuned to or receives the video-based broadcast (thus measuring the amount of time the same content and/or channel is being viewed either actively or passively). This may be representative of or a measure of the extent that the viewer is interested in the content of the video broadcast. As noted above, such level of interest may depend on the particular key information associated with the video broadcast. In this regard, a predetermined level of interest may be based on the video receiving device being tuned to or receiving the video-based broadcast for a predetermined amount of time. The predetermined amount of time may be constant or vary based on the broadcast type (sports, game show and/or commercial).

In one illustrative exemplary embodiment, video receiving device 10 is a mobile telephone (for example, a cellular handset) having a mobile television or video receiver (for example, the Telegent Systems TLG1100, TLG1120, TLG1121 and TLG1170 products) disposed therein and processing circuitry 18 to decode and/or interpret keyed or tagged video content provided in connection with one or more video broadcasts. The video receiving device 10 (and, in particular, processing circuitry 18), in response to detecting the video-based broadcast is an interactive video-based broadcast, determines, measures and/or detects the level of interest of the viewer to the video-based broadcast (for example, based on the length of time the viewer observes that broadcast or the video receiving device is tuned to the broadcast). In one embodiment, the video-based broadcast may be a product or service advertisement.

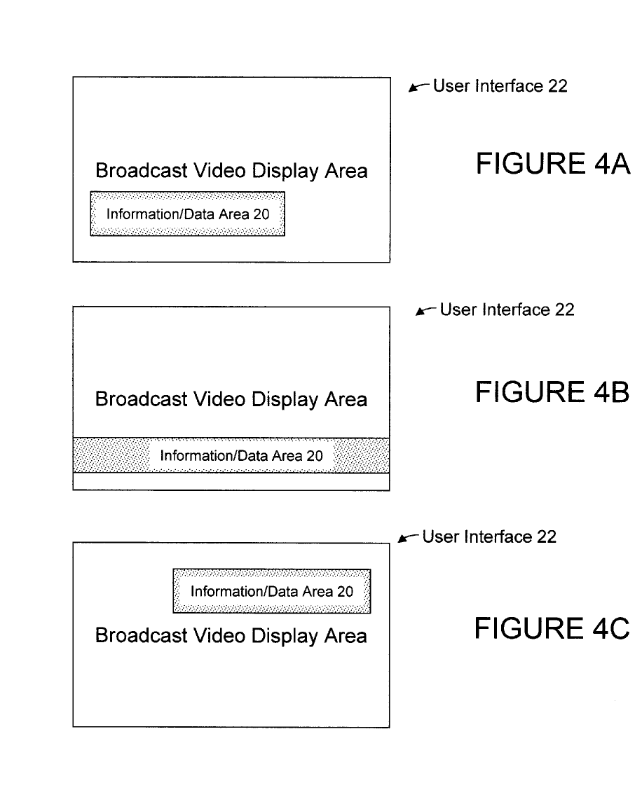

The video receiving device 10, upon detecting or determining a predetermined level of interest, may query central station 16 (via an alternative communication path, for example, an Internet connection or SMS communications link) to determine the content of the video-based broadcast (in this exemplary embodiment, a product or service advertisement). In response, central station 16 transmits or provides additional information to the video receiving device. With reference to FIGS. 4A-4C, in one embodiment, video receiving device 10, in response to the additional information, outputs a video insert and/or banner to a display of user interface 22 (see “Information/Data Area 20”). In this embodiment, video receiving device 10 may simultaneously display the video broadcast and the additional information.

The video insert or banner may display a query to the viewer regarding the product, service or advertisement thereof—for example, the viewer may be presented with a question regarding whether he/she would like (i) more information about that product or service, (ii) a coupon against the next purchase of the product or service, and/or (iii) one or more locations where the product may be purchased (for example, the nearest location(s)). Under the circumstances where the viewer responds “positively” to the query (for example, agrees to the query), video receiving device 10 responsively instructs or advises central station 16 which responsively transmits or provides second additional information. As noted above, the second additional information pertains to the query from central station 16 and, as such, the viewer response corresponds thereto.

Alternatively, the responses may be derived from or based on a database, look-up table or decision matrix stored in memory that is integrated in or resides locally within the receiving device. In this embodiment, the processing circuitry determines a response based on the database, look-up table or decision matrix. As such, some or all of the interactivity is local in that the processing circuitry determines a response based on the database, look-up table or decision matrix stored in memory. The database or look-up table may be instantiated at the time of manufacture and/or test of video receiving device 10 (or component thereof) and with responses then presented to the use as noted above. In addition thereto, or in lieu thereof, central station 16 may deliver a data (for example, a database, look-up table or decision matrix file) that is downloaded into the memory of video receiving device 10 which may modify, update, change, load and/or populate the memory employed by the processing circuitry.

Notably, in one aspect of the present inventions, transmitting or providing the first and/or second additional information or data may be a revenue bearing or generating event—for example, the telephone service provider, broadcaster and/or advertiser may charge the user/viewer/operator of video receiving device 10, the product manufacturer and/or the service provider for the additional advertisement (that is, the advertisement in addition to the “initial” video broadcast). With this in mind, in other aspects, the present inventions are directed to a system, video receiving device, and/or central station, as well as methods, to implement the above illustrative exemplary embodiments.

Although the previous illustrative exemplary embodiment was described in connection with a mobile telephone, the embodiment is applicable to any video receiving device (for example, a laptop computer, tablet PC, PMP, PND, or any device that has video receiving circuitry and a telecom or Internet link). All types of video receiving devices, which are consistent with one or more of these inventions, whether now known or later developed, are intended to fall within the scope of the present inventions.

In another illustrative exemplary embodiment, video receiving device 10 is a laptop or desktop computer having a television or video receiver disposed therein and circuitry to decode and/or interpret keyed or tagged video content provided in connection with one or more video broadcasts. Moreover, in this illustrative exemplary embodiment, the video-based broadcast may be a sporting event.

With that in mind, video receiving device 10, in response to detecting that the video-based broadcast is an interactive video-based broadcast, detects the level of interest of the viewer to the selected video-based broadcast. In this embodiment, however, video receiving device 10, upon detecting or determining an occurrence of an event associated with the broadcast, may present or provide additional information or data associated with the event. For example, video receiving device 10 (the laptop or desktop computer) may query (for example, periodically, intermittently or continuously) central station 16 (having, for example, a server assigned to monitor transmissions from one or more video receiving devices) via wired or wireless transmission (for example, an Internet communication) to determine the occurrence of an event associated with the broadcast (for example, in the context of a sporting event, whether a player has scored, for example, a goal, point or run). If such an event occurs, central station 16 may transmit, provide and/or deliver additional information or data to video receiving device 10, such as statistics on the player (for example, season and/or career) that scored the goal, point or run in information/data area 20. (See, for example, FIGS. 4A-4C). The video receiving device 10 may simultaneously display the video broadcast and the additional information or data, or offer to delay the display of the additional information or data.

Alternatively, rather than automatically presenting additional information or data associated with the event to video receiving device 10, the additional information or data may query the viewer, via information/data area 20 of video receiving device 10, as to whether he/she would like (i) more information about player that scored the goal, (ii) more information about the team of the player that scored the goal, and/or (iii) various statistics (for example, season and/or career) on the player that scored the goal, point or run. In this regard, in one embodiment, the video receiving device, in response to the additional information or data, displays a video insert and/or banner in information/data area 20 on the display of video receiving device 10. (See, for example, FIGS. 4A-4C). The video insert or banner may display the query to the viewer. Under the circumstances where the viewer responds “positively” to the query (for example, agrees to the query), video receiving device 10 responsively instructs or advises central station 16 which responsively transmits or provides the requested second additional information or data.

Similar to the previous illustrative exemplary embodiment, in one aspect of the present inventions, transmitting or providing the first and/or second additional information or data may be a revenue generating or bearing event—for example, the telephone provider, broadcaster and/or advertiser may charge the viewer/user/operator for the additional information or data. With this in mind, in other aspects, the present inventions are directed to a system, video receiving device, and/or central station, as well as methods, to implement these illustrative exemplary embodiments.

Notably, although the previous illustrative exemplary embodiment was described in connection with a laptop or desktop computer, the embodiment is applicable to any video receiving device (for example, a mobile telephone, tablet PC, PMP, PND, or any device that has video receiving circuitry and a telecom or internet link); all video receiving devices, whether now known or later developed, are intended to fall within the scope of the present inventions.

In yet another illustrative exemplary embodiment, video receiving device 10 may be a mobile telephone (for example, a cellular handset) having a television or video receiver (for example, the Telegent Systems TLG 1100, TLG1120, TLG1121 and TLG1170 products) disposed therein and circuitry to decode and/or interpret keyed or tagged video content provided in connection with one or more video broadcasts (for example, television or streaming video). The video receiving device 10, in response to detecting that the video-based broadcast is an interactive video-based broadcast, determines and/or detects the level of interest of the viewer to the video-based broadcast (for example, based on the length of time the viewer observes the broadcast). In this embodiment, the video-based broadcast may be a home improvement or development broadcast (for example, Divine Design or This Old House).

The video receiving device 10, upon detecting or determining a predetermined level of interest, may notify central station 16 (for example, via SMS communications protocol) of the predetermined level of interest. In response, central station 16 transmits or provides additional information or data to video receiving device 10. In one embodiment, video receiving device 10, in response to the additional information or data, displays a video insert and/or banner on the screen (see, for example, FIGS. 4A-4C)—for example, the video receiving device may simultaneously display the video broadcast and the first and/or second additional information or data.

The video insert or banner may display a query to the viewer regarding one or more products and/or services that are featured in the broadcast—for example, the viewer may be presented with a question regarding whether he/she would like (i) more information about a product or service discussed in the video-based broadcast, (ii) to be contacted by a sales person of one or more such products and or services, (iii) a coupon against the next purchase thereof, and/or (iv) one or more locations where the product or service is displayed and/or may be obtained (for example, the nearest location(s)). Under the circumstances where the viewer responds positively to the query (for example, agrees to the query), video receiving device 10 responsively instructs or advises central station 16 which may, based on the query, responsively transmit or provide second additional information or data in accordance with such viewer response. The video receiving device 10 may again simultaneously display the video broadcast and the second additional information or data.

As noted above, in one aspect of the present inventions, transmitting or providing the first and/or second additional information or data may be a revenue generating or bearing event—for example, the telephone provider, broadcaster and/or advertiser may charge the product manufacturer for the additional product advertisement (that is, the advertisement in addition to the “initial” video-based broadcast). With this in mind, in other aspects, the present inventions are directed to a system, video receiving device, and/or central station, as well as methods to implement the above illustrative exemplary embodiments.

Notably, the additional information or data may be, for example, graphical, textual, video and/or voice based type data.

As before, although the previous illustrative exemplary embodiment was described in connection with a mobile telephone, the embodiment is applicable to any video receiving device (for example, a laptop computer). All video receiving devices consistent with the inventions herein, whether now known or later developed, are intended to fall within the scope of the present inventions.

In another embodiment, the receiving device may store the users positive and/or negative interaction replies and usage behaviors (channel viewed, duration, etc) with regard to the respective tagged or keyed content. Indeed, the interaction data, and usage behavior as it corresponds to TV programs and specific interaction questions, represents data that when aggregated across multiple users provides or offers commercial value. In one embodiment, the broadcaster and/or central station 16 may obtain such interaction information or data—for example, if the user agrees to share the data either voluntary or in exchange for some form of compensation. In this regard, video receiving device 10 may transmit, for example, in response to user instruction and/or broadcaster and/or central station 16 request, such data or information (for example, transmit an interaction file that contains a log of the positive and/or negative responses and/or usage behavior) to the broadcaster or central station 16, for example, via telecom or internet link.

Importantly, the present inventions are neither limited to any single aspect nor embodiment, nor to any combinations and/or permutations of such aspects and/or embodiments. Moreover, each of the aspects of the present inventions, and/or embodiments thereof, may be employed alone or in combination with one or more of the other aspects and/or embodiments thereof. For the sake of brevity, many of those permutations and combinations will not be discussed and/or illustrated separately herein.

The key information may be provided, transmitted and/or available to the video receiving device simultaneously or concurrently with the video broadcast, and/or before such broadcast is provided, transmitted and/or available to the video receiving device, and/or after such broadcast is provided, transmitted and/or available to the video receiving device. The key data may be embedded within the video-based broadcast, separate therefrom and/or determined from, for example, other data or information, for example, an electronic program guide. All types, forms and/or manners of transmission, and circuitry or configurations for providing and/or transmitting key information are intended to fall within the scope of the present inventions.

Further, the present inventions may be implemented in conjunction with any type of video receiver circuitry, transmit circuitry and/or processing circuitry (including discrete devices or integrated devices), whether now known or later developed. All types and forms of video receiver circuitry, transmit circuitry and processing circuitry (consistent with the inventions herein) are intended to fall within the scope of the present inventions.

For example, in the exemplary embodiments hereof, the circuitry to decode and/or interpret keyed or tagged video content (for example, processing circuitry 18), as well as the circuitry to detect, measure and/or assess the level or amount of interest may be comprised of or include one or more microprocessors, state machines, Application-Specific Integrated Circuits (ASICs), digital signal processors (DSPs), and/or programmable gate arrays (for example, field-programmable gate arrays (FPGAs)). Indeed, such circuitry may be any type or form of circuitry whether now known or later developed. For example, the circuitry may include a single component or a multiplicity of components (microprocessors, state machines, FPGAs, ASICs and DSPs), either active and/or passive, integrated or not, which are coupled together to implement, provide and/or perform a desired operation/function/application; all of which are intended to fall within the scope of the present inventions. Moreover, all permutations and/or combinations of hardwired and programmable circuitry (which is programmed, for example, via software) for implementing the operations (for example, transmitting, receiving, decoding, processing and evaluating circuitry) within the video receiver device described herein are intended to fall within the scope of the present inventions.

Notably, one, some or all of the present inventions may provide, enable and/or facilitate one, some or all of the following advantages:
“automatic” interactivity with what was originally a one-way television broadcast;
enhance “participation TV” programming that uses SMS texting for voting such as the Pop Idol or Big Brother franchises by making voting easier and integrating voting directly into the viewing experience through automated queries to vote with the telecom ability to cast such a vote;
facilitate and increase operator derived revenue from SMS and data services
real-time information that is of interest to the user based on what they are viewing at the time;
collection of user viewing habits/interests by the device, either for automated recommendation of other content or for collection by a service provider (for example, a cellular operator, broadcaster, or marketing/advertising agency) for data mining purposes;
additional advertising revenue for broadcasters of video content, as well as the service providers for the device (for example, mobile/cellular operators);
targeted advertising;
interactive “chat rooms” based on video programming (for example, SMS during a sporting event, etc);
“static” video content with interactive features; and/or
collection of user viewing habits/interest data.

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the above embodiments of the inventions are merely exemplary. They are not intended to be exhaustive or to limit the inventions to the precise forms, techniques, materials and/or configurations disclosed. Many modifications and variations are possible in light of this disclosure. It is to be understood that other embodiments may be utilized and operational changes may be made without departing from the scope of the present inventions. As such, the scope of the inventions is not limited solely to the description above because the description of the above embodiments has been presented for the purposes of illustration and description.

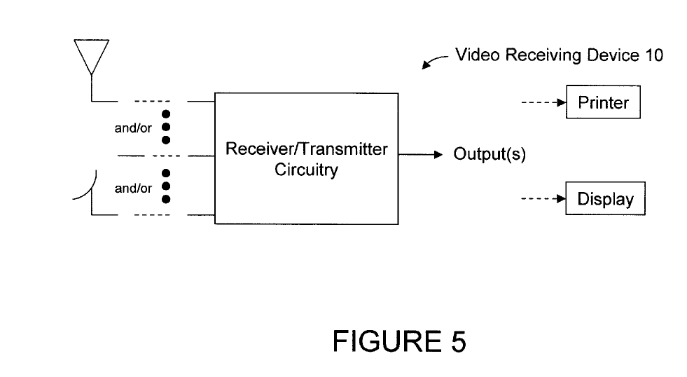

For example, video receiving device 10 may output data which is representative of the additional information or data to, for example, a printer and/or video display. (See, for example, FIG. 5). In one embodiment, video receiving device 10 may download and/or output data which is representative of a coupon for the product (as described above). In this regard, video receiving device 10 may download data which is representative of a coupon and thereafter transfer such coupon to a vendor (in electronic or paper form) in connection with the purchase of a product.

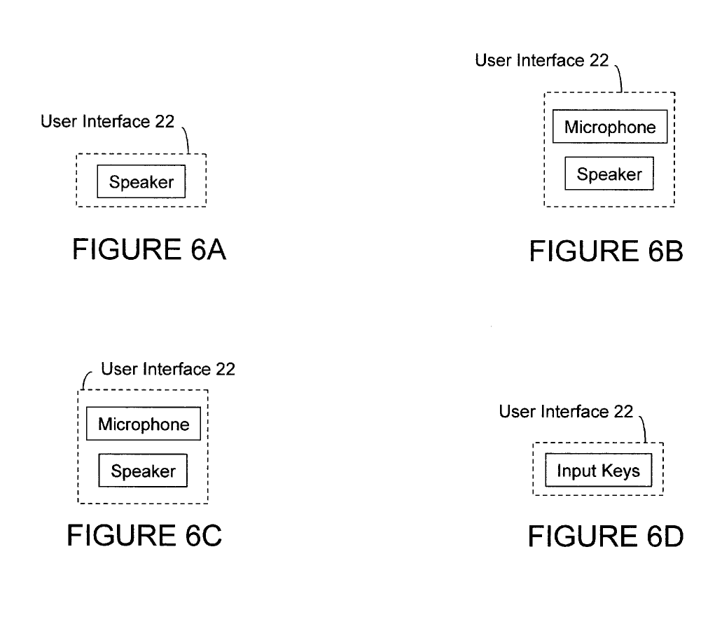

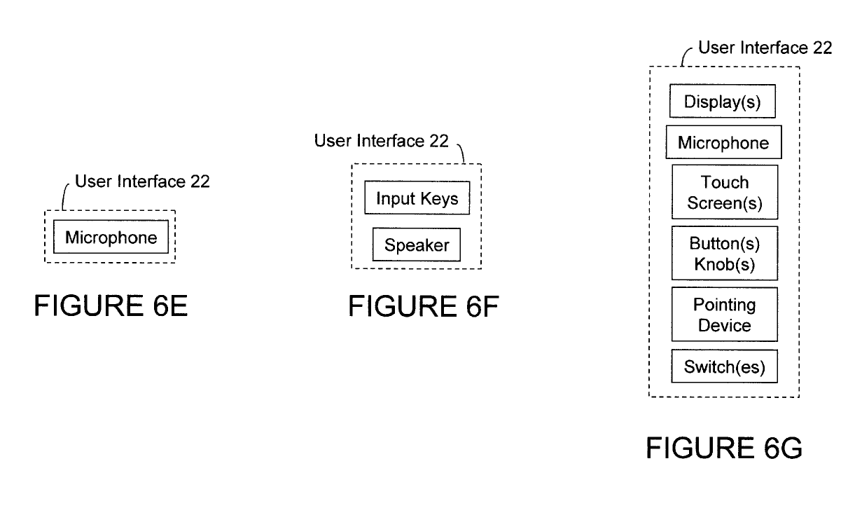

Moreover, in addition to (or in lieu of) a video display, user interface 22 may include one or more of a speaker, microphone, secondary video display (for example, to display the additional information or data) and/or user input devices/input keys/buttons/switches. (See, for example, FIGS. 6A-6G). Indeed, any manner of inputting of viewer commands or responses to, for example, queries presented via additional information or data, are intended to fall within the scope of the present inventions.

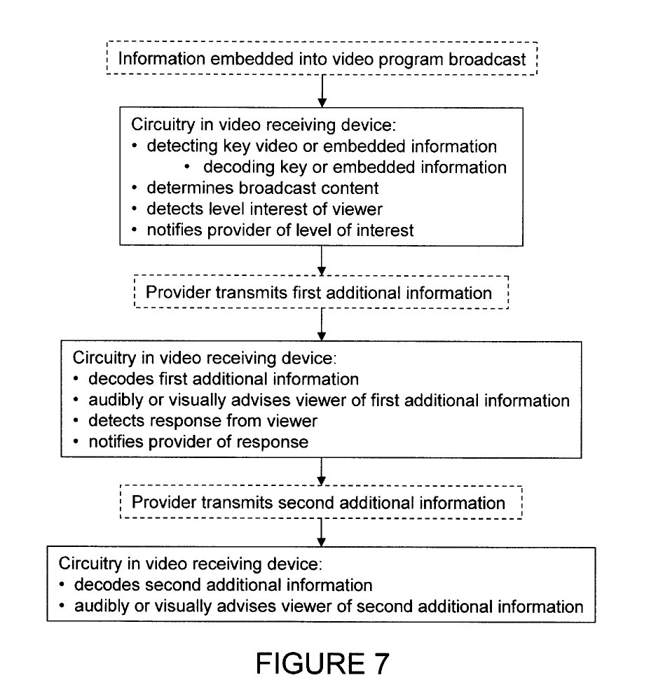

Notably, an exemplary flow of operation, in the context of keyed or tagged video content, is illustrated in FIG. 7.

Further, in addition to displaying data which is representative of the additional information or data (for example, queries or data from the central station), the additional information or data may be audibly provided to the viewer, user or operator of the video receiving device. As such, although the illustrative exemplary embodiments discussed herein describe providing the viewer with additional information or data via, for example, a video insert or banner, such information may be provided to the viewer as audio via a speaker. (See, for example, FIG. 7). For the sake of brevity, such discussions will not be repeated.

In another embodiment, video receiving device 10 includes circuitry and techniques to analyze, decode, detect and/or determine information (for example, programming content or the like) using data output or provided to a video display and/or from data actually displayed on such video display. Such circuitry and techniques may employ pixel comparisons and/or optical character or pixel recognition upon data that is output or provided to or displayed on a video display (for example, a video display integrated into the video receiving device). As such, in this embodiment, the video receiving device decodes, analyzes and/or determines programming content (or the like) from data output or provided to a video display and/or from data actually displayed on such video display.

Notably, the processing circuitry of video receiving device 10 may employ any character recognition technique now known or later developed. Ass such techniques are intended to fall within the scope of the present invention.

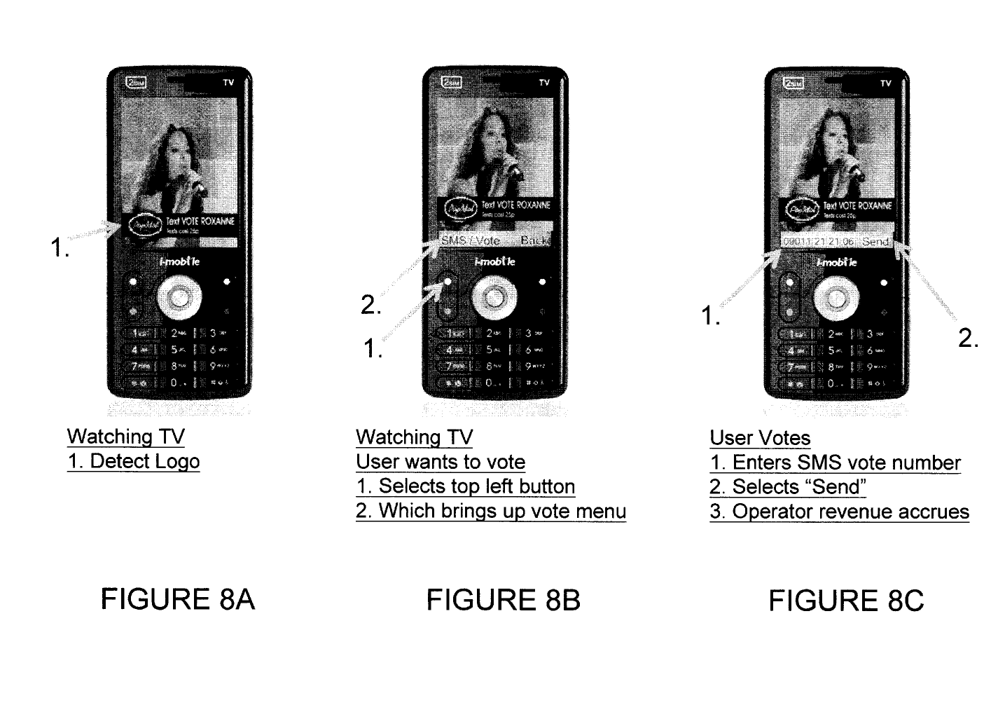

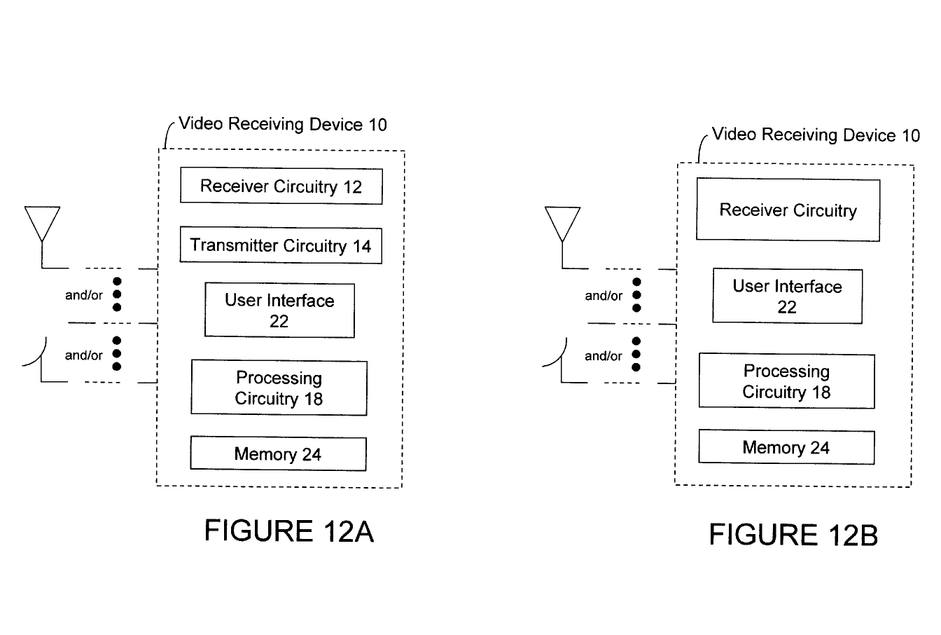

For example, in one embodiment, processing circuitry 18 may detect and/or determine a broadcast (and, in response, create a pop-window during participation TV game shows that employ SMS voting) using, for example, character recognition of logos of certain TV programs of interest and/or database or lookup tables for pixel patterns, colors, sizes, etc. (See, “1” in FIG. 8A). In this embodiment, one or more logos of certain TV programs may be stored in memory 24 (whether discrete or integrated in, for example, processing circuitry 18) of video receiving device 10 and/or system memory. (See, for example, FIGS. 12A and 12B). The memory 24 of the logo may map specific pixel colors, pixel arrangement, etc of the specific logo to create a display “signature” for the logo and, as such, the broadcast or programming content. When live content is being displayed, processing circuitry 18 may compare, detect, analyze and/or use the current pixel content sent to the video display to determine one or more “signatures” stored in, for example, memory. When processing circuitry 18 detects or determines a “match” (for example, the configuration or the pixel content correlates to or matches data stored in memory), video receiving device 10 may generate a message to the viewer (for example, via a pop-up window which provides the user with interaction). For example, where the programming is determined to be a TV game show, the processing circuitry may present the user or operator an opportunity to make an SMS vote or a pop-up window is provided which provides an option to link the user to the programs website. (See, “2” in FIGS. 8B and 8C).

Again, processing circuitry 18 may employ any character recognition technique now known or later developed. Ass such techniques are intended to fall within the scope of the present invention.

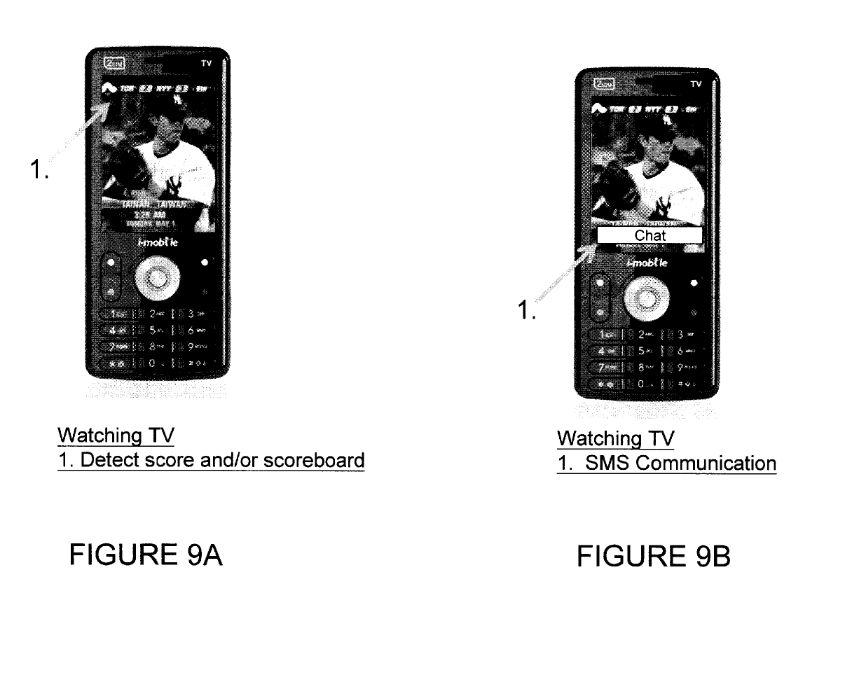

In another example, certain program or broadcast event types display information in a consistent manner such as the display of the sports score during soccer, baseball, football, or other sporting events. The processing circuitry 18 of video receiving device 10 may detect, for example, data which is representative of a box score or scoreboard on the display or in data provided to the display. (See, “1” in FIG. 9A). The processing circuitry 18 may detect such information based on, for example, different common forms of score reporting (black numbers within a white field at the top or bottom of the screen) which may be stored in memory in the video receiving device and/or system memory. The memory 24 may store an archive of the sport score which maps specific pixel colors, pixel arrangement, etc to create a display “signature” for sport scores. When live content is being displayed, processing circuitry 18 compare, detect, analyze and/or use the current pixel content sent to the video display to determine one or more “signatures” of the broadcast stored in, for example, memory resident in/on the video receiving device. For example, processing circuitry 18 may compare the current pixel content sent to the screen for display for comparison against the sport score display signatures stored in memory. (See, FIG. 9A). In the event a “match” is detected or determined (for example, when the processing circuitry correlates or matches a configuration or the pixel content to data stored in memory (for example, by comparing such data to data or information stored in a database or look-up table)), a pop-up window may be provided that enables the user to communication with anther (for example, to send an SMS message (to update a friend of the score)) or a pop-up window is provided which provides an option to link the user to the website of the respective event or other relevant sport sites. (See, “2” in FIG. 9B).

Notably, in addition to video data based analysis, or in lieu thereof, the video receiving device may analyze audio data. In this regard, processing circuitry 18 may parse the audio content of a broadcast. In this embodiment, the audio is sent to the output driver and also audio speech to text processing is run. A lookup table (stored, for example, in memory 24) may be accessed by processing circuitry 18 which compares the text (transcribed from the audio) to stored text or variables. In one embodiment, processing circuitry 18 employs or implements a decision matrix to determine or detect if, in one embodiment, a specific word or phrase is detected or used enough times to create the algorithm assumption that a specific form of content is being viewed by the user. In this exemplary embodiment, if the audio speech to text processing records and correctly matches the word “baseball” to one of the stored terms, the algorithm can assume that the viewer is watching a baseball game and then a pop-up window is provided that enables the user to communicate with another (for example, send an SMS message (to update a friend of the score)) or a pop-up window is provided which provides an option to link the user to the website of the respective event or other relevant sport sites.

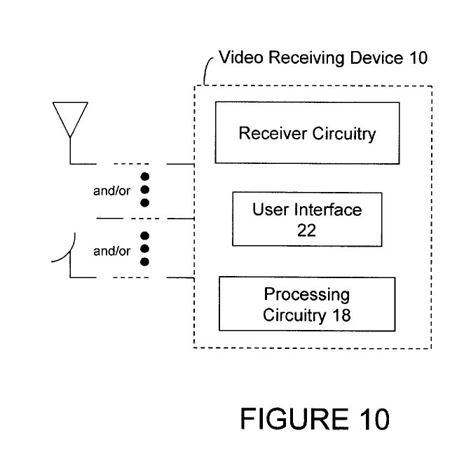

In another embodiment, with reference to FIGS. 1, 10, 12A and 12B, video receiving device 10 includes circuitry and techniques to analyze, decode, detect and/or determine programming content information available from, for example, the broadcast signal including, for example, programming content information included or embedded, for example, in the vertical blanking interval (VBI information). In addition thereto, or in lieu thereof, video receiving device 10 may decode, analyze and/or determine programming content from teletext information (or the like) available from or in the broadcast signals. Here, video receiving device 10 and, in particular, processing circuitry 18 (or processing circuitry that interfaces with or to video receiving device 18) may access memory which includes a database, lookup table and/or decision matrix whereby processing circuitry 18 provides incremental feature options available to the user or operator based upon, for example, the decoded VBI information or teletext content information. For example, processing circuitry 18, based on the look-up table or decision matrix, may generate data to provide, for example, a pop-window to purchase a service or product, providing a pop-window with the option to place a vote for a participation TV game show (via for example, SMS communications protocol or an Internet TCP/IP connection), or providing a pop-window for the user to visit the website of the program content show, network, or advertisement. Notably, processing circuitry 18 may also generate the lookup table or decision matrix.

In another embodiment, video receiving device 10 may decode and/or analyze closed-captioning (CC) content information provided in or available from the broadcast signals. The video receiving device (and, in particular, processing circuitry 18 or processing circuitry coupled to device 10) may access memory which includes a lookup table or decision matrix whereby the processor circuitry provides incremental feature options available to the consumer product user based upon using character recognition (for example, optical character recognition) to decode, analyze and/or determine CC information. In response thereto, the processing circuitry may generate data to display information, for example, a pop-window to purchase a service or product, providing a pop-window with the option to place an SMS vote for a participation TV game show, or providing a pop-window for the user to visit the website of the program content show, network, or advertisement. (See, for example, FIGS. 4A-4C).

Notably, processing circuitry 18 may also generate the lookup table or decision matrix. Moreover, processing circuitry 18 may employ any character recognition technique now known or later developed. Ass such techniques are intended to fall within the scope of the present invention.

In addition thereto, or in lieu thereof, with reference to FIGS. 1, 10, 12A and 12B, processing circuitry 18 of video receiving device 10 (or processing circuitry that interfaces with or to the video receiving device) may analyze, decode and/or detect text information (for example, CC content information), which is provided with and/or embedded in the audio and video content of the broadcast, to search such broadcast to identify and/or detect predetermined and/or key text, words and/or phrases. In response to identifying or detecting such predetermined and/or key text, words and/or phrases, processing circuitry 18 of video receiving device 10 (or processing circuitry that interfaces with or to the video receiving device) generates or provides contextually relevant presentations to the user or viewer, for example, a video insert or banner on the display. The predetermined and/or key text, words and/or phrases may be stored in memory on or in the video receiving device (or processing circuitry that interfaces with or to the video receiving device).

As noted above, the contextually relevant presentation(s) may be provided in video form (for example, an insert or banner on the display) and/or audio form via a speaker coupled to or integrated in the video receiving device. (See, for example, FIGS. 4A-4C and 6A-6F). Moreover, any manner of inputting of viewer commands or responses to, for example, contextually relevant presentation(s) are intended to fall within the scope of the present inventions. For example, the user interface may include a speaker, microphone, secondary video display (for example, to display the additional information or data) and/or input keys/buttons/switches. (See, for example, FIGS. 6A-6F).

The user selected, predetermined and/or key text, words and/or phrases may be or may relate to a product, advertisement and/or a “jingle”—for example, “Have a Pepsi” or “Drink a Coke.” For example, where the video receiving device is a mobile device or a computer and the broadcast (for example, TV broadcast) includes the phrase “Have a Pepsi” or “Drink a Coke”, the processing circuitry of the video receiving device (or processing circuitry that interfaces with or to the video receiving device) may analyze, decode and/or detect the CC content information and, upon determining or detecting the word or phrase including “Pepsi” or “Coke” (which was or was included in a predetermined and/or key text, word or phrase), generate, provide and/or present a contextually relevant presentation including, for example, a link to Pepsi's or Coke's website. Indeed, the user or viewer may be presented, for example, with a question regarding whether he/she would like (i) more information about that product or service, (ii) a coupon against the next purchase of the product or service, and/or (iii) one or more locations where the product may be purchased (for example, the nearest location(s)).

With reference to FIGS. 1, 10, 12A and 12B, in another exemplary embodiment, processing circuitry 18 of video receiving device 10 (or processing circuitry that interfaces with or to the video receiving device) is configured to analyze and/or decode the broadcast (for example, television broadcast) to detect or identify telephone numbers, website or texting instructions such as the text or phrase “Call 1-800-555-5555”. In this regard, the predetermined and/or key text, words and/or phrases may be a telephone number, website or texting information or instruction. The circuitry of the video receiving device may, in response to detecting such predetermined and/or key text, word and/or phrase, generate and display a window or a button dialing option to the telephone number or site. In this example, the contextually relevant presentation is the window or a button dialing option to the telephone number or site. As such, the user may rapidly and/or immediately access or engage the window or a button dialing option of the telephone number or site.

Notably, the user may interact with the broadcast via responding to the contextually relevant presentation (for example, select or engage the window or a button dialing option to the telephone number or site). Thereafter, additional information or data regarding the video-based broadcast may be specifically and/or uniquely directed to the viewer via the interactive video receiving device (for example, video (graphic or text) and/or audio based). Such interaction may be, for example, a telephone call or site access to the information provided via the contextually relevant presentation and the additional information or data may be video or voice based data. That is, the additional information or data may be, for example, graphical, textual, video and/or voice based type data.

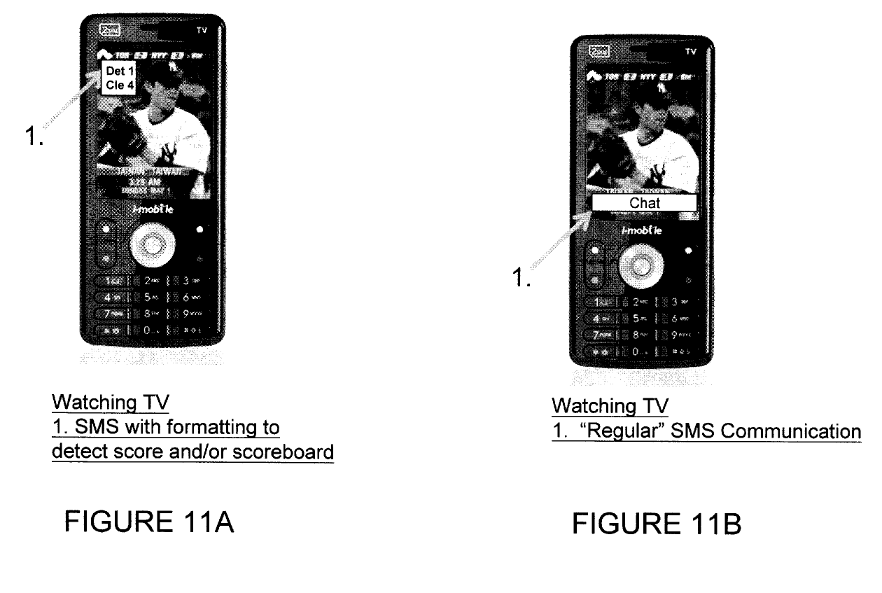

In another embodiment, video receiving device 10 includes circuitry and techniques to concurrently receive and/or display different communication mediums including (i) a TV broadcast and (ii) an overlay of specially designed SMS text messages. (See, for example, FIGS. 4A-4C, 8B, 8C, 9A, 11A and 11B). In this regard, the circuitry and techniques presents the SMS (or the like) as an overlay (for example, a graphical overlay) with respect to the picture or image generated from the TV broadcast. Thus, in this embodiment, the circuitry receives, analyzes, decodes and/or detects one or more specially designed text messages and, in response thereto, generates a graphical overlay of their contents on a broadcast TV picture. (See, for example, “1” in FIG. 11A).

Notably, the text messages may include or contain formatted command words or messages or originate from a specific source (i.e. SMS originating from a configured number). In this regard, when video receiving device 10 (for example, mobile phone) which is tuned to a TV broadcast concurrently receives, analyzes, decodes and/or detects one or more messages containing command words, the circuitry in device 10 may generate and display additional on-screen information. The on-screen information may be, for example, sports scores, stock ticker information, news updates, etc. Indeed, the set of command words or messages may include commands to implement specific actions such as contact another viewer or friend (for example, via SMS communication) to, for example, suggest a TV program and/or change the selected channel thereof.

For example, consider the following SMS message; “SCORE: T1:Det S1:1 T2:CIe S2:4”. (See, “1” in FIG. 11A). The data processing circuitry may parse the message and find the word “SCORE” which indicates this is a special SMS message. Further parsing of T1 (team one) and S1 (score for team one) would result in the video display of “Det 1” versus T2 and S2 result of “Cle 4”. The receiving device may display this SMS generated information in a form that differs from normal SMS text messages. The video receiving device may facilitate contacting another person or device (for example, via SMS communication) to, for example, “chat”. (See, for example, “1” in FIG. 11B).

Notably, the characters, phrases and other data stored in memory which is used by processing circuitry 18 to analyze, determine, decode and/or detect information from a broadcast may be preloaded in memory 24 and/or downloaded, modified and/or updated in situ thereto, for example, periodically, intermittently and/or upon user instruction.

Here again, the user may interact with the broadcast via responding to the contextually relevant presentation. Thereafter, additional interactivity may be provided. For example, in response to the user's response to contextually relevant presentation, additional information or data associated with the contextually relevant presentation may be specifically and/or uniquely directed to the viewer via the interactive video receiving device (for example, video (graphic or text) and/or audio based). Such interaction may be, for example, additional information or data pertaining to the sports scores, stock ticker information, news updates, etc which was provided via the contextually relevant presentation. Notably, the additional information or data may be, for example, graphical, textual, video and/or voice based type data.

Importantly, each of the aspects of the present inventions, and/or embodiments thereof, may be employed alone or in combination with one or more of such aspects and/or embodiments. For the sake of brevity, those permutations and combinations will not be discussed separately herein. As such, the present inventions are not limited to any single aspect or embodiment thereof nor to any combinations and/or permutations of such aspects and/or embodiments.

As noted above, there are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the above embodiments of the inventions are merely exemplary. They are not intended to be exhaustive or to limit the inventions to the precise forms, techniques, materials and/or configurations disclosed. Many modifications and variations are possible in light of this disclosure. It is to be understood that other embodiments may be utilized and operational changes may be made without departing from the scope of the present inventions. As such, the scope of the inventions is not limited solely to the description above because the description of the above embodiments has been presented for the purposes of illustration and description.

It should be noted that the term “circuit” may mean, among other things, a single component or a multiplicity of components (whether in integrated circuit form or otherwise), which are active and/or passive, and which are coupled together to provide or perform a desired function. The term “circuitry” may mean, among other things, a circuit (whether integrated or otherwise), a group of such circuits, one or more processors, one or more state machines, one or more processors implementing software, one or more gate arrays, programmable gate arrays and/or field programmable gate arrays, ora combination of one or more circuits (whether integrated or otherwise), one or more state machines, one or more processors, one or more processors implementing software, one or more gate arrays, programmable gate arrays and/or field programmable gate arrays.

Further, in operation, the processing circuitry may perform or execute one or more applications, routines, programs and/or data structures that implement particular methods, techniques, tasks or operations described and illustrated herein. The functionality of the applications, routines or programs may be combined or distributed. Further, the applications, routines or programs may be implementing by the processing circuitry using any programming or operating language whether now known or later developed, including, for example, assembly, FORTRAN, C, C++, and BASIC, whether compiled or uncompiled code; all of which are intended to fall within the scope of the present inventions.

Notably, the term “data” may mean, among other things, a current or voltage signal(s) whether in an analog or a digital form, which may be a single bit (or the like) or multiple bits (or the like).

It should be further noted that the various circuits and circuitry disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Indeed, when received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

What is claimed is:

1. A method of operating and interacting with a video receiving device, the method comprising:
receiving a video-based broadcast, wherein the video-based broadcast includes video data and key data, wherein the key data is indicative of an interactive video-based broadcast;
displaying the video-based broadcast;
decoding the key data and, in response thereto, determining the video-based broadcast is an interactive type video-based broadcast;
detecting a predetermined level of interest of the user in the video-based broadcast;
transmitting data which is indicative of the predetermined level of interest of the user in the video-based broadcast;
receiving first additional information in response to transmitting the data which is indicative of predetermined level of interest of the user in video-based broadcast, wherein the first additional information is associated with the video-based broadcast;
concurrently displaying the video-based broadcast and data which is representative of the first additional information;
detecting a response from the user to the first additional information; and
transmitting data which is indicative of the response from the user to the first additional information.

2. The method of claim 1 wherein the key data is embedded in the video data of the video-based broadcast.

3. The method of claim 1 wherein the key data is embedded within one or more vertical blanking intervals of the video data of the video-based broadcast.

4. The method of claim 1 wherein the key data is embedded within teletext information of the video-based broadcast.

5. The method of claim 1 wherein the key data is included in the closed-captioning data.

6. The method of claim 1 wherein concurrently displaying the video-based broadcast and data which is representative of the first additional information further includes displaying the data which is representative of the first additional information as a video insert or a graphic overlay with respect to the video-based broadcast.

7. The method of claim 1 wherein the key data is information or data which is representative of one or more characteristics of the associated video-based broadcast.

8. The method of claim 1 wherein detecting a predetermined level of interest of the user in video-based broadcast is based on an amount of time of displaying the video-based broadcast.

9. A method of operating and interacting with a video receiving device having a user interface, the method comprising:
receiving a video-based broadcast;
receiving key data which is associated with the video-based broadcast;
displaying the video-based broadcast;
decoding the key data and, in response thereto, determining the video-based broadcast is an interactive type video-based broadcast;
detecting a level of interest of the user in video-based broadcast based on an amount of time of displaying the video-based broadcast;
transmitting data which is indicative of the level of interest;
receiving first additional information in response to transmitting the data which is indicative of the level of interest;
outputting data which is representative of the first additional information to the user interface;
detecting a response from the user to the first additional information; and
transmitting data which is indicative of the response from the user to the first additional information.

10. The method of claim 9 wherein receiving key data which is associated with the video-based broadcast includes receiving information pertaining to the content of the associated video-based broadcast via content-specific electronic program guide.

11. The method of claim 9 wherein outputting data which is representative of the first additional information to a user interface includes displaying data which is representative of the first additional information.

12. The method of claim 11 wherein displaying data which is representative of the first additional information further includes displaying the data which is representative of the first additional information as a video insert, a graphic overlay, or formatted text with respect to the video-based broadcast.

13. The method of claim 9 wherein the key data is embedded within one or more vertical blanking intervals of the video data of the video-based broadcast.

14. The method of claim 9 wherein the key data is included in the closed-captioning data.

15. The method of claim 9 wherein the key data is embedded in the video data of the video-based broadcast.

16. The method of claim 9 wherein displaying the data which is representative of the first additional information further includes displaying the data which is representative of the first additional information as a SMS text message overlay on the video-based broadcast.

17. The method of claim 9 further including:
receiving second additional information in response to transmitting the data which is indicative of the response from the user to the first additional information;
outputting data which is representative of the second additional information to the user interface; and
detecting a response from the user to the second additional information.

18. The method of claim 17 wherein outputting data which is representative of the second additional information to the user interface further includes displaying data which is representative of the second additional information.

19. A method of operating and interacting with a video receiving device having a user interface, the method comprising:
receiving a video-based broadcast, wherein the video-based broadcast includes video data and text data embedded therein;
displaying the video-based broadcast;
analyzing the text data and, in response thereto, identifying predetermined and/or text, words and/or phrases of the text data; and
outputting a contextually relevant presentation to the user interface in response to identifying the predetermined and/or text, words and/or phrases.

20. The method of claim 19 wherein outputting the contextually relevant presentation to the user interface in response to identifying the predetermined and/or text, words and/or phrases further includes displaying a predetermined video insert on the user interface, wherein the predetermined video insert is associated with the predetermined and/or text, words and/or phrases of the text data.

21. The method of claim 19 wherein outputting the contextually relevant presentation to the user interface in response to identifying the predetermined and/or text, words and/or phrases further includes presenting the user with a link to a website which is associated with the predetermined and/or text, words and/or phrases of the text data.

22. The method of claim 19 wherein outputting the contextually relevant presentation to the user interface in response to identifying the predetermined and/or text, words and/or phrases further includes providing the user with a product purchase coupon which is associated with the predetermined and/or text, words and/or phrases of the text data.

23. The method of claim 19 wherein outputting the contextually relevant presentation to the user interface in response to identifying the predetermined and/or text, words and/or phrases further includes providing the user with information which is representative of one or more physical locations which are correlated to an acquisition of a product that is associated with the predetermined and/or text, words and/or phrases of the text data.

24. The method of claim 19 wherein outputting the contextually relevant presentation to the user interface in response to identifying the predetermined and/or text, words and/or phrases further includes concurrently displaying the video-based broadcast and data which is representative of the contextually relevant presentation.

25. The method of claim 24 wherein concurrently displaying the data which is representative of the contextually relevant presentation includes displaying the data which is representative of the contextually relevant presentation as a video insert or a graphic overlay with respect to the video-based broadcast.

26. The method of claim 19 wherein the text data is embedded within one or more vertical blanking intervals of the video data of the video-based broadcast.

27. The method of claim 19 wherein the text data is included in the closed-captioning data.

28. The method of claim 19 wherein outputting contextually relevant presentation to the user interface in response to identifying the predetermined and/or text, words and/or phrases further includes displaying data which is representative of the contextually relevant presentation as a SMS text message overlay on the video-based broadcast.

29. The method of claim 19 further including:
detecting a response from the user to the contextually relevant presentation which is output to the user interface in response to identifying the predetermined and/or text, words and/or phrases.

30. The method of claim 29 further including:
transmitting data which is indicative of the response from the user to the contextually relevant presentation.

31. The method of claim 30 further including:
receiving first additional information in response to transmitting the data which is indicative of the response from the user to the contextually relevant presentation; and
outputting data which is representative of the first additional information to the user interface.

32. The method of claim 31 further including:
detecting a response from the user to the first additional information; and
transmitting data which is indicative of the response from the user to the first additional information.

33. A method of operating and interacting with a video receiving device having a user interface, the method comprising:
receiving a video-based broadcast;
displaying video data which is representative of the video-based broadcast;
analyzing the video data to identify predetermined information contained therein, wherein the predetermined information includes logos, words and/or numbers, and wherein analyzing the video data includes analyzing the color, shape and/or pattern representations of the video data; and
outputting one or more contextually relevant presentations to the user interface in response to identifying the predetermined information contained therein.

34. The method of claim 33 wherein analyzing the video data to identify predetermined information contained therein further includes comparing color, shape and/or pattern representations of the video data to corresponding data in a database or look-up table which is representative of one or more logos, words and/or numbers.
